(19) United States
(12) Patent Application Publication
(10) Pub. No.: US 2024/0046032 A1
(43) Pub. Date: Feb. 8, 2024

(54) INFORMATION PROCESSING APPARATUS AND METHOD FOR CONTROLLING THE SAME, STORAGE MEDIUM, AND INFORMATION PROCESSING SYSTEM

(71) Applicant: CANON KABUSHIKI KAISHA, Tokyo (JP)

(72) Inventor: Takuya SAITO, Chiba (JP)

(21) Appl. No.: 18/360,095

(22) Filed: Jul. 27, 2023

(30) Foreign Application Priority Data
Aug. 8, 2022 (JP) 2022-126486

(51) Int. Cl. G06F 40/174

(52) U.S. Cl. CPC G06F 40/174

(57) ABSTRACT

An information processing apparatus which is capable of saving the time and effort in performing various types of registrations regarding the information processing apparatus. The information processing apparatus acquires location information of a mobile terminal by using the mobile terminal in vicinity of the information processing apparatus, receives, from a conversion server, address information obtained by the location information of the mobile terminal converted, generates a superimposed image by superimposing the address information on an address entry field of the format image of a registration sheet, and outputs the superimposed image.

### BACKGROUND OF THE INVENTION

### Field of the Invention

The present invention relates to an information processing apparatus and a method for controlling the same, a storage medium, and an information processing system.

### Description of the Related Art

Conventionally, in order to receive support for purchased information processing apparatuses, the users need to perform various types of registrations such as a guarantee registration and a user registration. Examples of a way to the registration include a registration via the Web and a registration by FAX/mail. The registration by FAX/mail is used, for example, in a case where an account required for a registration via the Web fails to be prepared. For the registration by FAX/mail, the user writes personal information on the user themself, information on the model name and machine body number of the information processing apparatus, and the like, in a registration sheet in handwriting, and submits the written registration sheet to the provider of the information processing apparatus by FAX/mail. Japanese Laid-Open Patent Publication (kokai) No. 2009-169725 proposes a method for printing an image to be printed while fixed information registered in advance being superimposed on the image to be printed.

It takes the user a time and effort to collect information required for the registration (for the entry of the registration sheet) and write the information in the registration sheet in handwriting. Thus, it is conceivable to apply the printing technique described in Japanese Laid-Open Patent Publication (kokai) No. 2009-169725 to the registration sheet. The fixed information registered in advance in the information processing apparatus does not necessarily include, however, all the information required for filling in the registration sheet, and in a case where the fixed information does not include all of the required information, it is difficult to apply the printing technique described in Japanese Laid-Open Patent Publication (kokai) No. 2009-169725 to the registration sheet. In addition, also for the registration via the web, it takes the user a time and effort additionally collect information required for filling in the registration sheet on the screen and manually input the information into the registration sheet on the screen.

### SUMMARY OF THE INVENTION

The present invention provides an information processing apparatus which is capable of saving the time and effort in performing various types of registrations regarding the information processing apparatus, a controlling method therefor, a storage medium, and an information processing system.

Accordingly, the present invention provides an information processing apparatus comprising at least one memory that stores a set of instructions, and at least one processor that is configured to, based on the instructions, cause the information processing apparatus to acquire location information of a mobile terminal by using the mobile terminal in vicinity of the information processing apparatus receive, from a conversion server, address information obtained by the location information of the mobile terminal converted generate a superimposed image by superimposing the address information on an address entry field of the format image of a registration sheet, and output the superimposed image.

According to the present invention, the time and effort can be saved in performing various types of registrations regarding the information processing apparatus.

Further features of the present invention will become apparent from the following description of exemplary embodiments with reference to the attached drawings.

### BRIEF DESCRIPTION OF THE DRAWINGS

FIG. 1 is a diagram showing examples of: a hardware configuration of a multi-function peripheral; and a hardware configuration of a mobile terminal.

FIG. 2 is a diagram showing an example of a system configuration of an information processing system.

FIG. 3 is a diagram showing examples of screens displayed on an operation part of a multi-function peripheral according to a first embodiment.

FIG. 4 is a flowchart of processing performed in the multi-function peripheral according to the first embodiment.

FIG. 5 is a diagram showing an example of a registration sheet.

FIG. 6 is a flowchart of processing performed in a registration management server and a flowchart of processing performed in a location information conversion server, according to the first embodiment.

FIG. 7 is a diagram showing examples of screens displayed on an operation part of a multi-function peripheral according to a second embodiment.

FIG. 8 is a flowchart of processing performed in the multi-function peripheral according to the second embodiment.

FIG. 9 is a flowchart of processing performed in a registration management server according to the second embodiment.

### DESCRIPTION OF THE EMBODIMENTS

The present invention will now be described in detail below with reference to the accompanying drawings showing embodiments thereof. The configurations described in the following respective embodiments are, however, considered by way of example only, and the scope of the present invention is not limited by the configurations described in the respective embodiments. For example, each part constituting the present invention can be replaced with a part that has any configuration, which can achieve the same function. In addition, any constituent may be added. In addition, of the respective embodiments, any two or more configurations (features) can also be combined. In each of the embodiments, a multi-function peripheral (digital multi-function peripheral/MFP/Multi Function Peripheral) will be described as an example of the information processing apparatus according to the present invention. The scope of the present invention is, however, not limited to the multifunction peripheral, and may be any device capable of processing data such as information, and the information processing apparatus also encompasses an image forming apparatus and an image processing apparatus.

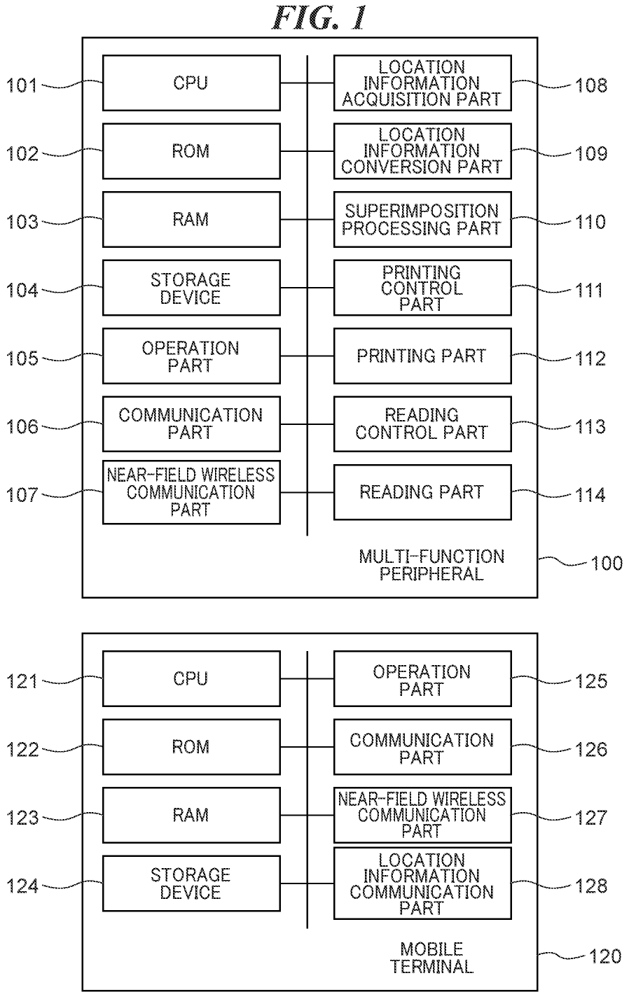

Hereinafter, a first embodiment will be described with reference to FIGS. 1 to 6. In the first embodiment, a case of printing a registration sheet will be described. The registration sheet is intended to be submitted by the user to the provider (distributor or the like) of a multi-function peripheral 100 to receive a guarantee registration. FIG. 1 is a diagram showing examples of: a hardware configuration of a multi-function peripheral 100; and a hardware configuration of a mobile terminal 120. As shown in FIG. 1, the multi-function peripheral 100 includes a CPU 101, a ROM 102, a RAM 103, a storage device 104, an operation part 105, a communication part 106, and a near-field wireless communication part 107. The CPU 101 executes a control program for the multi-function peripheral 100 to control the entire multi-function peripheral 100. The ROM 102, which is configured by a flash memory, stores a control program for the multi-function peripheral 100. The RAM 103 is a volatile memory that is configured to temporarily store program control variables, processed image data, and the like.

The storage device 104, which is an HDD device or the like, is a nonvolatile memory that stores image data and the like. The storage device 104 also stores data such as the model name and machine body number of the multi-function peripheral 100, as related information related to the multi-function peripheral 100. The operation part 105 is an interface part with a user that displays information in the multi-function peripheral 100, and is provided with a liquid crystal display part that has a touch panel function. The communication part 106 is an interface part between the multi-function peripheral 100 and an external communication network. The near-field wireless communication part 107 is an interface for near-field wireless communication such as near field communication (NFC) or Bluetooth (registered trademark). The near-field wireless communication part 107 communicates with the mobile terminal 120 or the like in the vicinity of the multi-function peripheral 100 to exchange data.

The multi-function peripheral 100 further includes a location information acquisition part 108, a location information conversion part 109, a superimposition processing part 110, a printing control part 111, a printing part 112, a reading control part 113, and a reading part 114. The location information acquisition part 108 acquires a latitude/longitude, which is location information, from the mobile terminal 120 connected via the near-field wireless communication part 107. The location information conversion part 109 receives and then converts the latitude/longitude acquired by the location information acquisition part 108 to create an address character string. The superimposition processing part 110 receives the address character string or the like created by the location information conversion part 109, and performs superimposition processing on a predetermined location of the format image of a registration sheet. The printing control part 111 applies image processing to the input image data to generate print data. The printing part 112 receives the print data generated by the printing control part 111 and then transferred therefrom, and prints the print data on a recording medium such as paper. The reading control part 113 performs processing in accordance with settings for reading a document image and/or settings for image data generated by the reading part 114. The reading part 114 reads a document image to generate image data. It should be noted that the reading control part 113 and the reading part 114 are not essential components in the present invention.

The mobile terminal 120 includes a CPU 121, a ROM 122, a RAM 123, a storage device 124, an operation part 125, a communication part 126, a near-field wireless communication part 127, and a location information communication part 128. The CPU 121, the ROM 122, the RAM 123, the storage device 124, the operation part 125, the communication part 126, and the near-field wireless communication part 127 have configurations that are equivalent to the above-described corresponding constituent parts in the multi-function peripheral 100, denoted by the reference numeral 101 to 107. The location information communication part 128 communicates with the global positioning system, and acquires a latitude/longitude that is location information on the mobile terminal 120.

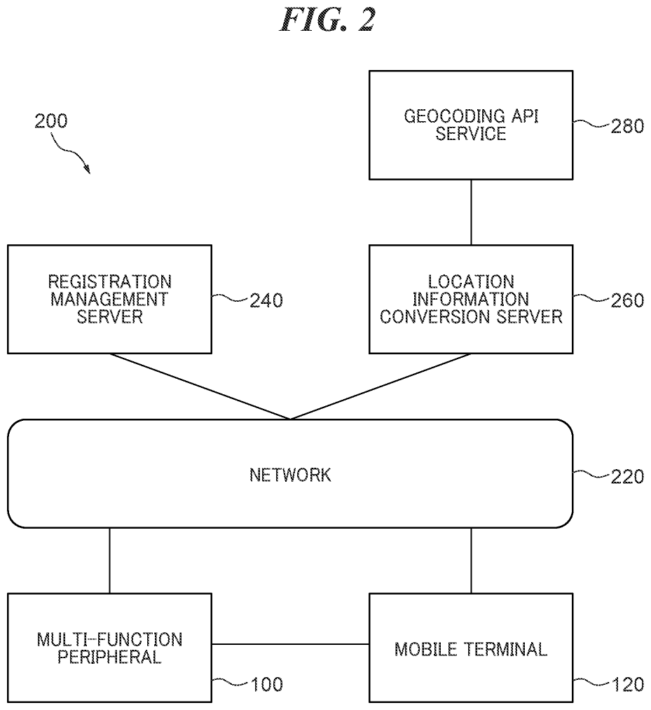

FIG. 2 is a diagram showing an example of a system configuration of an information processing system 200. As shown in FIG. 2, in the information processing system 200, the multi-function peripheral 100, a registration management server 240, and a location information conversion server 260 are connected via a network 220. The registration management server 240 is a server that manages information on a registrant, and manages the format image of a registration sheet. The location information conversion server 260 acquires an address character string generated by converting the latitude/longitude and received from the multi-function peripheral 100, with the use of a geocoding API service 280 such as Google Maps (registered trademark). It should be noted that the location information conversion server 260 may have a configuration in which, with information such as a latitude/longitude and an address being held as a database, the location information conversion server 260 itself performs conversion processing to generate an address character string. The multi-function peripheral 100 and the mobile terminal 120 are connected to each other by near-field wireless communication such as NFC or Bluetooth (registered trademark) mounted on the respective near-field wireless communication parts 107 and 127. In addition, the mobile terminal 120 can also be connected to the multi-function peripheral 100 or the like via the network 220.

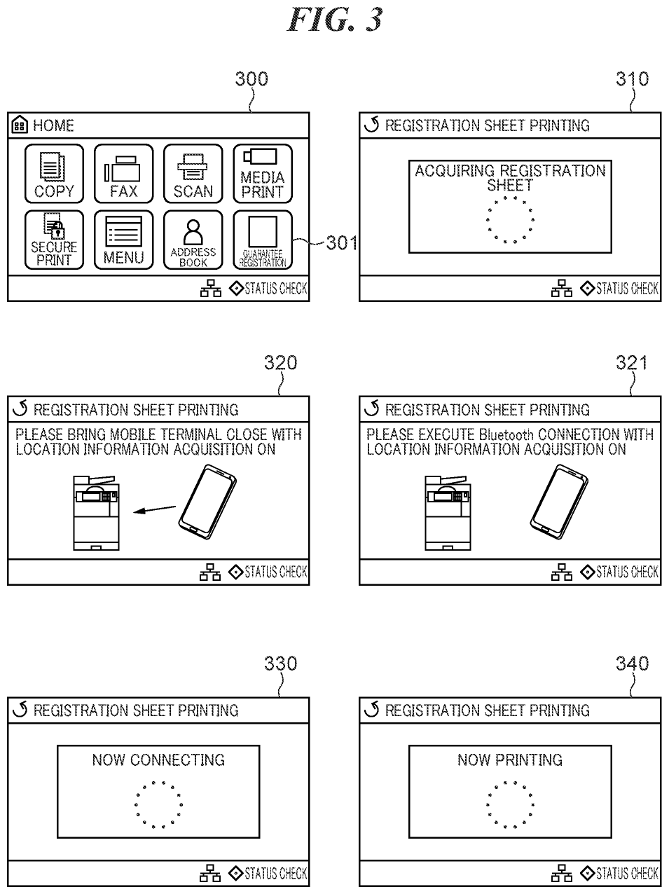

FIG. 3 is a diagram showing examples of screens displayed on the operation part 105 of the multi-function peripheral 100 according to the first embodiment. When the user presses a button 301 for a guarantee registration function on a menu list screen 300 displayed on the operation part 105 of the multi-function peripheral 100, an application for registration sheet printing is executed. When the execution of the application for registration sheet printing is started, a registration sheet acquiring screen 310 indicating that a format image of a registration sheet is waiting to be acquired is displayed on the operation part 105. Then, when the multi-function peripheral 100 receives the format image of the registration sheet from the registration management server 240, a connection request screen 320 that prompts (requests) the user to connect to the mobile terminal 120 is displayed on the operation part 105. It should be noted that depending on the type of near-field wireless communication used for the connection between the multi-function peripheral 100 and the mobile terminal 120, for example, a screen 321 may be displayed on the operation part 105, instead of the connection request screen 320.

When the connection between the multi-function peripheral 100 and the mobile terminal 120 is established, a connection processing screen 330 is displayed on the operation part 105, and processing of converting location information is started in the multi-function peripheral 100. Then, when the multi-function peripheral 100 receives the address information including an address character string from the location information conversion server 260, a printing processing screen 340 is displayed on the operation part 105, and the multi-function peripheral 100 performs superimposing processing and printing processing of the format image of a registration sheet and the address character string. When the printed paper is discharged from the multi-function peripheral 100, the display screen of the operation part 105 transitions to the menu list screen 300 to end the execution of the application for registration sheet printing.

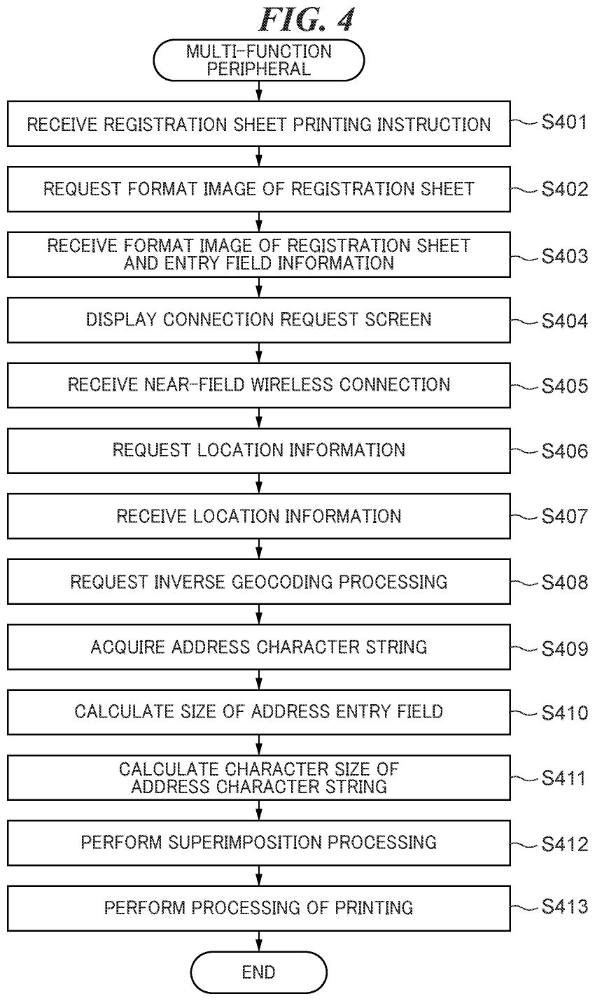

FIG. 4 is a flowchart of processing performed in the multi-function peripheral 100 according to the first embodiment. The CPU 101 (computer) reads a control program (program) stored in the ROM 102 into the RAM 103, and then executes the control program, thereby implementing the processing in steps S401 to S413 (method for controlling an information processing apparatus) of the flowchart.

In the step S401, the CPU 101 receives a registration sheet printing instruction from the operation part 105. The registration sheet printing instruction is output from the operation part 105 by the user pressing the button 301 for the guarantee registration function on the menu list screen 300 of the operation part 105. In the step S402, the CPU 101 transmits a registration sheet transmission request to the registration management server 240 via the communication part 106 (first transmitting unit). Accordingly, the CPU 101 requests the registration management server 240 to transmit the format image of a registration sheet. Further, the CPU 101 displays the registration sheet acquiring screen 310 on the operation part 105. In the step S403, the CPU 101 receives the format image of the registration sheet and each piece of entry field information from the registration management server 240 via the communication part 106 (first receiving unit/first receiving step/first receiving unit).

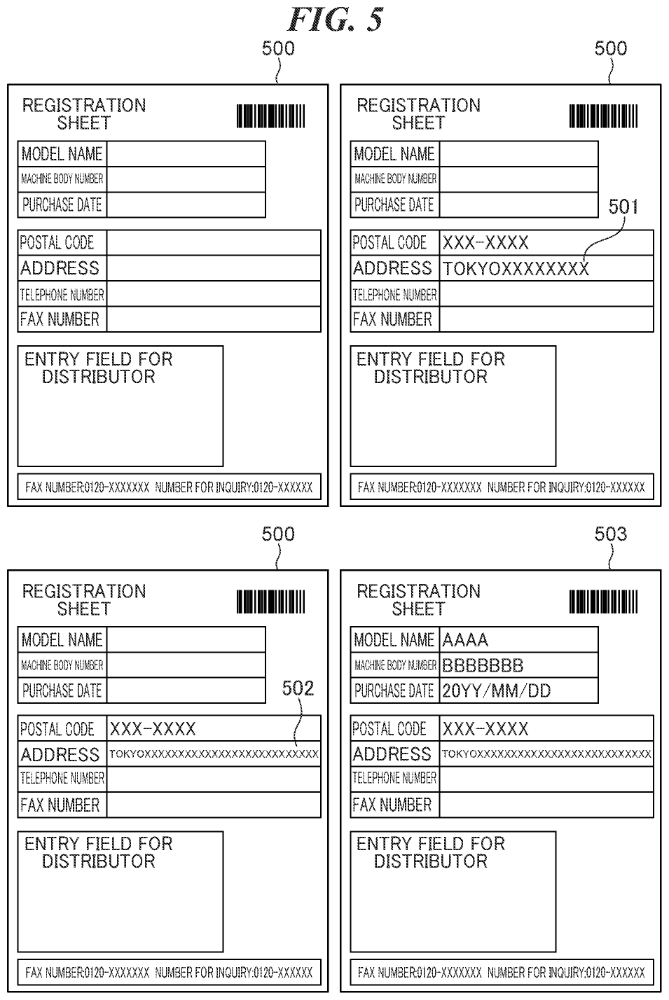

FIG. 5 is a diagram showing an example of a registration sheet. The registration management server 240 holds the format image of a registration sheet such as a registration sheet 500. Each piece of the entry field information described above includes arrangement information on entry items or arrangement information on the entry fields corresponding to the entry items in the format image of the registration sheet. The information on the arrangement includes, for example, information on the coordinates of the upper left corner and lower right corner of the entry field.

The description returns to FIG. 4. In the step S404, the CPU 101 displays the connection request screen 320 on the operation part 105. Accordingly, the CPU 101 requests the user to establish a connection between the multi-function peripheral 100 and the mobile terminal 120. It should be noted that the CPU 101 may use different display screens of the operation part 105 such as the screens 320, 321 described above, depending on the type of near-field wireless communication that can be used for the multi-function peripheral 100. In addition, the CPU 101 may provide, on the screen of the operation part 105, a screen on which the user can select the type of near-field wireless communication.

In the step S405, the CPU 101 receives a near-field wireless connection from the mobile terminal 120 via the near-field wireless communication part 107. When the connection between the multi-function peripheral 100 and the mobile terminal 120 is established in this manner, the CPU 101 displays the connection processing screen 330 on the operation part 105. In the step S406, the CPU 101 requests the mobile terminal 120 to transmit location information via the near-field wireless communication part 107. In the step S407, the CPU 101 receives the location information from the mobile terminal 120 via the near-field wireless communication part 107 (location acquiring unit/location acquiring step). Furthermore, the CPU 101 causes the location information acquisition part 108 to acquire the latitude/longitude indicating the location of the mobile terminal 120, from the location information received from the mobile terminal 120.

In the step S408, the CPU 101 requests the location information conversion server 260 to perform converting processing, that is, inverse geocoding processing on the acquired latitude/longitude, via the communication part 106 (second transmitting unit). Hereinafter, the request for the reverse geocoding processing is referred to as a “conversion request”. Furthermore, the CPU 101 transmits the latitude/longitude received from the mobile terminal 120 to the location information conversion server 260 via the communication part 106. In the step S409, the CPU 101 receives address information from the location information conversion server 260 via the communication part 106 (second receiving unit/second receiving step/second receiving unit). Furthermore, the CPU 101 causes the location information conversion part 109 to acquire an address character string from the address information received from the location information conversion server 260. The address character string corresponds to the latitude/longitude indicating the location of the mobile terminal 120. That is, the address information received from the location information conversion server 260 is the address information of the mobile terminal 120.

In the step S410, the CPU 101 acquires the arrangement information on the address entry field from each piece of the entry field information received in the step S403, and then calculates the size of the address entry field. In the step S411, the CPU 101 calculates the character size of the address character string, based on the size of the address entry field and the length of the address character string (first determining unit). For example, in the case of an address character string 501 shown in FIG. 5, the character string is small in length, and thus, the maximum size in which the height of the character fits with respect to the height of the address entry field is determined to be the character size of the address character string 501. In contrast, in the case of an address character string 502 shown in FIG. 5, the character string is large in length, and thus, the maximum size in which the length of the character string fits with respect to the length of the address entry field is determined to be the character size of the address character string 502. The character size of the address character string 501 or 502 is determined in this manner, thus allowing the address character string 501 or 502 to be fit in the address entry field of the format image of the registration sheet in an appropriate character size.

The description returns to FIG. 4. In the step S412, the CPU 101 causes the superimposition processing part 110 to perform superimposition processing, based on the arrangement information on the address entry field, the address character string, and the character size (superimposing unit/superimposing step). In the superimposition processing, for example, the CPU 101 sets, as a drawing start point, the coordinates of the upper left corner of the address entry field included in each piece of the received entry field information, in the format image of the received registration sheet, and draws the address character string in the calculated character size. In this manner, a superimposed image is generated in which the address character string is drawn to be superimposed on the address entry field of the format image of the registration sheet. In the step S413, the CPU 101 causes the printing control part 111 and the printing part 112 to perform processing of printing the superimposed image generated in the step S412 (outputting unit/outputting step). Thereafter, the printed paper is discharged, and the registration sheet with the address printed in the address entry field is thus completed. Further, during the processing of printing, the CPU 101 displays the printing processing screen 340 on the operation part 105. In addition, when the printed paper is discharged, the CPU 101 switches the display screen of the operation part 105 to the menu list screen 300.

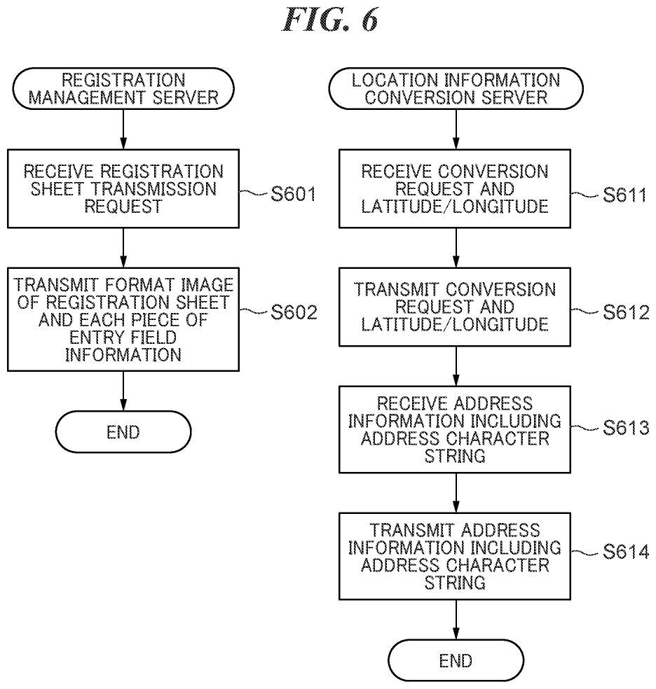

FIG. 6 shows a flowchart of processing performed in the registration management server 240 and a flowchart of processing performed in the location information conversion server 260, according to the first embodiment. In the step S601, the registration management server 240 receives the registration sheet transmission request transmitted by the CPU 101 of the multi-function peripheral 100 in the step S402 (receiving unit). In the step S602, the registration management server 240 transmits, to the multi-function peripheral 100, the format image of a registration sheet and each piece of entry field information in accordance with the received registration sheet transmission request (transmitting unit).

In the step S611, the location information conversion server 260 receives the conversion request and latitude/longitude transmitted by the multi-function peripheral 100 (CPU 101) in the step S408 (receiving unit). In the step S612, the location information conversion server 260 transmits the conversion request to the geocoding API service 280, together with the received latitude/longitude. It should be noted that the geocoding API service 280 converts the received latitude/longitude into an address character string corresponding to the latitude/longitude. In the step S613, the location information conversion server 260 receives, from the geocoding API service 280, the location information (address information) including the address character string corresponding to the latitude/longitude which is received from the multi-function peripheral 100 and then transmitted to the geocoding API service 280 (converting unit). In the step S614, the location information conversion server 260 transmits, to the multi-function peripheral 100, the location information (address information) including the address character string corresponding to the latitude/longitude which is received from the multi-function peripheral 100 and then transmitted to the geocoding API service 280 (transmitting unit).

As described above, according to the first embodiment, the use of the location information of the mobile terminal 120 allows the multi-function peripheral 100 to create, by printing, the registration sheet in which the address indicating the location of the mobile terminal 120 is entered in the address entry field. Accordingly, the use of the location information of the mobile terminal 120 in the vicinity of the multi-function peripheral 100 allows the multi-function peripheral 100 to create, by printing, the registration sheet in which the address indicating the location of the multi-function peripheral 100 is entered in the address entry field, thus allowing the time and effort to be saved in performing various types of registrations such as a guarantee registration.

Further, a character string indicating a postal code can also be drawn in a postal code entry field in the format image of the registration sheet in the similar manner to the address character string described above. More specifically, the multi-function peripheral 100 can create, by printing, the registration sheet in which the postal code of an address indicating the location of the multi-function peripheral 100 is entered in the postal code entry field (see FIG. 5). In this case, the character string indicating the postal code is received from the location information conversion server 260 together with the location information including the address character string in the step S409, for example.

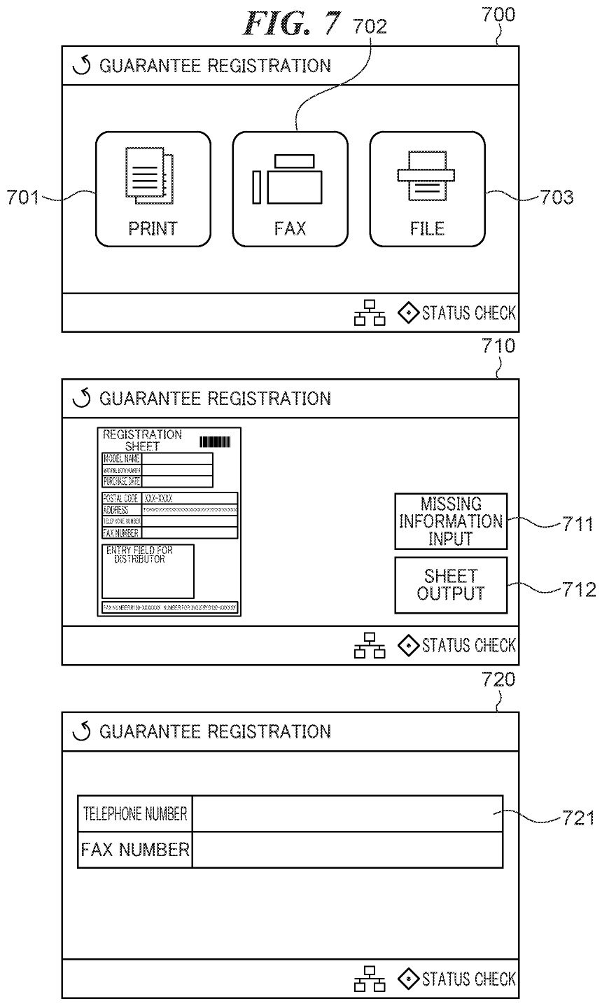

Hereinafter, a second embodiment will be described with reference to FIGS. 7 to 9. The hardware configuration of the multi-function peripheral 100 and the hardware configuration of the mobile terminal 120 according to the second embodiment are the same as the hardware configuration of the multi-function peripheral 100 and the hardware configuration of the mobile terminal 120 according to the first embodiment. While the registration sheet to be submitted to the provider of the multi-function peripheral 100 is created by printing, for receiving the guarantee registration in the first embodiment, the registration sheet may be submitted by FAX transmission/file transmission of the data of the registration sheet to the provider of the multi-function peripheral 100. Accordingly, a case in which the user can make a guarantee registration even by a method other than the submission of the registration sheet created by printing will be described in the second embodiment. Namely, an example in which the user can select a guarantee registration method from among printing, FAX transmission, and file transmission will be described in the second embodiment.

In a case in which the data of a registration sheet is subjected to FAX transmission/file transmission, the registration sheet cannot be touched up in handwriting, as is distinct from the case of using the printed registration sheet. Thus, FAX transmission/file transmission of the data of the registration sheet is required, with all necessary information drawn on the format image of the registration sheet. In view of this situation, according to the second embodiment, in addition to the address character string subjected to the superimposition processing according to the first embodiment, superimposition processing is also performed for information required for the format image of the registration sheet, acquired from related information held in the multi-function peripheral 100, and for information input by the user. It should be noted that the related information held in the multi-function peripheral 100 is information related to the multi-function peripheral 100, including the model name, machine body number, and the like of the multi-function peripheral 100, and is stored in the storage device 104.

FIG. 7 is a diagram showing examples of screens displayed on the operation part 105 of the multi-function peripheral 100 according to the second embodiment. Hereinafter, differences from the first embodiment will be mainly described. When the user presses the button 301 for the guarantee registration function on the menu list screen 300 (FIG. 3) displayed on the operation part 105 of the multi-function peripheral 100, a first selection screen 700 on which the user can select the guarantee registration method is displayed on the operation part 105 as shown in FIG. 7. The first selection screen 700 is provided with a print button 701, a fax button 702, and a file button 703. The print button 701 is a button for the user to select a method same as/similar to the method in the first embodiment (method for using a printed registration sheet) as a guarantee registration method. The fax button 702 is a button for the user to select FAX transmission as a guarantee registration method. The file button 703 is a button for the user to select file transmission as a guarantee registration method. It should be noted that the file transmission is performed in a format such as a portable document format (PDF).

When the user presses any one of the print button 701, the fax button 702, and the file button 703, the above-described registration sheet acquiring screen 310 is displayed on the operation part 105. Thereafter, the display screen of the operation part 105 transitions to the connection request screen 320 and the connection processing screen 330 in the order as described above, in the similar manner to the first embodiment. Then, when the processing of superimposing the address character string and the like on the format image of the registration sheet is completed, the display screen of the operation part 105 transitions to a preview screen 710.

A preview of the superimposed image is displayed on the preview screen 710. In a case where the entry fields of the format image of the registration sheet are not all filled at the time of the completion of the superimposition processing for the address character string and the like, an input button 711 for missing information is displayed on the preview screen 710. When the user presses the input button 711 for missing information, the display screen of the operation part 105 transitions to a second selection screen 720. The second selection screen 720 has only entry fields (blank) and entry items therefor displayed. The case where the entry fields of the format image of the registration sheet are not all filled is a case where no information to be superimposed on the entry fields can be acquired from either the location information received from the mobile terminal 120 or the related information held in the multi-function peripheral 100.

For example, in the case of the registration sheet 503 shown in FIG. 5, the entry field corresponding to the entry item of the telephone number and the entry field corresponding to the entry item of the FAX number are blank. Thus, on the second selection screen 720, the entry field corresponding to the entry item of the telephone number and the entry field corresponding to the entry item of the FAX number are displayed. Then, on the second selection screen 720, for example, when the user presses the entry field 721 corresponding to the entry item of the telephone number, the user can input, into the entry field 721, characters to be entered in the entry field corresponding to the entry item of the telephone number on the registration sheet 503.

In addition, a sheet output button 712 is displayed on the preview screen 710. When the user presses the sheet output button 712, the superimposed image is output and printing of the registration sheet or FAX transmission/file transmission of the data of the registration sheet is performed, by the guarantee registration method selected by the user on the first selection screen 700. That is, the guarantee registration method means a method for outputting the superimposed image. It should be noted that in a case where the entry fields of the format image of the registration sheet are not all filled, the sheet output button 712 is grayed out, and not allowed to be pressed by the user. It should be noted that in a case where the guarantee registration method selected by the user on the first selection screen 700 is the method in which the printed registration sheet is used, the sheet output button 712 does not have to be grayed out because the printed registration sheet can be touched up in handwriting.

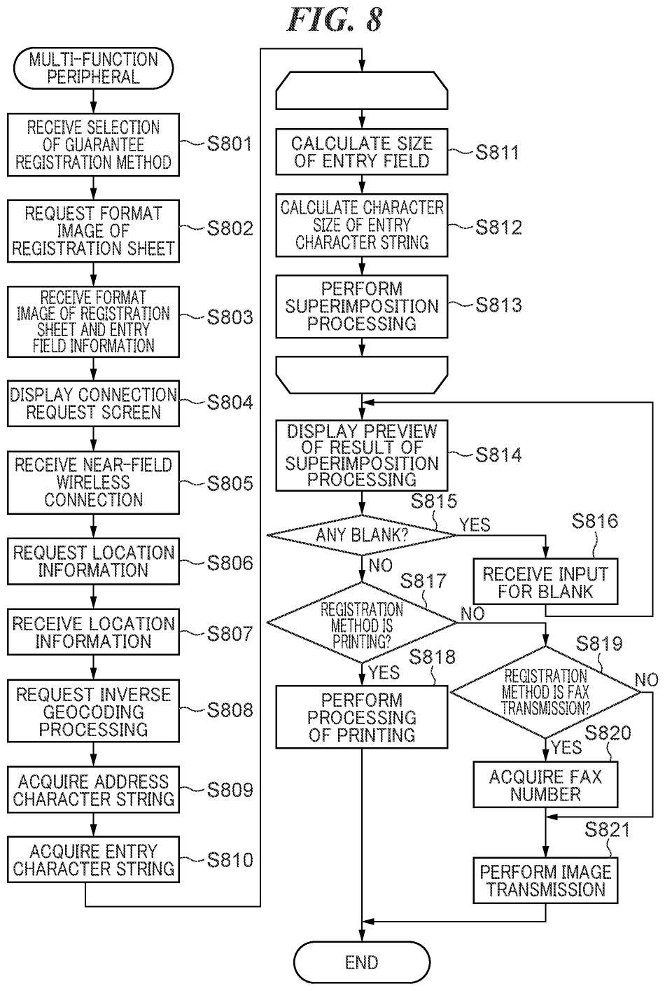

FIG. 8 is a flowchart of processing performed in the multi-function peripheral 100 according to the second embodiment. The CPU 101 reads a control program stored in the ROM 102 into the RAM 103, and then executes the control program, thereby implementing the processing in steps S801 to S821 of the flowchart. Hereinafter, differences from the first embodiment will be mainly described.

In the step S801, the CPU 101 receives the selection of the guarantee registration method from the operation part 105 (selecting unit). The selection of the guarantee registration method is output from the operation part 105 by the user pressing any one of the print button 701, the fax button 702, and the file button 703 on the first selection screen 700 (selection screen) of the operation part 105. At this time, the user can recognize all of the selectable guarantee registration methods on the first selection screen 700, and thus, the user can select the guarantee registration method, which is convenient for the user. In the steps S802 to S809, the CPU 101 performs the processing similar to the processing in the steps S402 to S409 according to the first embodiment. In the step S810, the CPU 101 acquires an entry character string (entry information) corresponding to each entry field of the format image of the registration sheet (information acquiring unit). Specifically, the CPU 101 acquires an entry character string(s) indicating the model name and machine body number of the multi-function peripheral 100 from the related information stored in the storage device 104.

In the steps S811 to S813, the CPU 101 performs the processing similar to the processing in the steps S410 to S412 according to the first embodiment. More specifically, in S811, for each entry field including the address entry field described above, the CPU 101 calculates the size of each entry field from the arrangement information on each entry field by the method similar to the calculation method of the size of the address entry field described above. In S812, for each entry character string including the address character string described above, the CPU 101 calculates the character size of each entry character string, based on the size of each entry field and the length of each entry character string, by the method similar to the calculation method of the character size of the address character string described above. In S813, the CPU 101 performs superimposition processing, based on the arrangement information on each entry field, each entry character string, and the character size of each entry character string, by the method similar to the method described above. The processing in the steps S810 to S813 is repeatedly performed until the address character string acquired in the step S809 and the entry character string acquired in the step S810 are respectively superimposed on the corresponding entry fields, in the format image of the registration sheet. That is, the step S812 corresponds to a second determining unit.

In the step S814, the CPU 101 displays the preview screen 710 on the operation part 105. On the preview screen 710 at this time, the superimposed image obtained in the step S813 when the repeated superimposition processing is completed is displayed as a preview of a result of the superimposition processing. In the step S815, the CPU 101 determines whether the superimposed image has a blank or not. In a case where the CPU 101 determines that the superimposed image has a blank, the CPU 101 displays the input button 711 for missing information on the preview screen 710 of the operation part 105. Then, when the user presses the input button 711 for missing information, the processing proceeds to the step S816. In contrast, in a case where the CPU 101 determines that the superimposed image has no blank, the processing proceeds to the step S817.

In the step S816, the CPU 101 displays the second selection screen 720 (first input screen) on the operation part 105, and receives input information input by the user as information corresponding to the blank of the superimposed image (input receiving unit). In this processing, by pressing the blank (entry field 721) on the second selection screen 720, the user can input, in the said blank, characters to be entered in the blank of the superimposed image. Then, the character string of the characters input is superimposed on the corresponding blank in the superimposed image. Thus, in addition to the entry field corresponding to the entry item of the telephone number and the entry field corresponding to the entry item of the FAX number as described above, for example, the entry field corresponding to the entry item of a purchase date can be filled as shown in the registration sheet 503 in FIG. 5.

In this manner, the user can fill the blank of the superimposed image, that is, the blank of the registration sheet. Furthermore, the user can recognize a blank and characters input in the blank on the second selection screen 720, and thus easily performs an operation of inputting information. Thereafter, the processing returns to the step S814. It should be noted that, on the preview screen 710 at this time, a superimposed image obtained when the character string of the characters (information) input in the step S816 is superimposed on the format image of the registration sheet is displayed in addition to the character string displayed in the previous preview. In this manner, the processing in the steps S814 to S816 is repeatedly performed until the superimposed image has no blank. It should be noted that the return from the step S816 to the step S814 may be performed on condition that the superimposed image has no blank in the step S816.

In and after the step S817, output processing is performed. In the step S817, the CPU 101 determines whether the selection of the guarantee registration method is printing or not. This determination is made, based on the button which is pressed by the user in the step S801 out of the print button 701, the fax button 702, and the file button 703 on the first selection screen 700. In a case where the button pressed by the user in the step S801 is the print button 701, it is determined that the selection of the guarantee registration method is printing. In a case where the CPU 101 determines that the selection of the guarantee registration method is printing, the processing proceeds to the step S818. In contrast, in a case where the CPU 101 determines that the selection of the guarantee registration method is not printing, the processing proceeds to the step S819. In the step S818, the CPU 101 performs processing of printing in the similar manner to the processing in the step S413 according to the first embodiment (outputting unit).

In the step S819, the CPU 101 determines whether the selection of the guarantee registration method is FAX transmission or not. This determination is made, based on the button which is pressed by the user in the step S801 out of the print button 701, the fax button 702, and the file button 703 on the first selection screen 700. In a case where the button pressed by the user in the step S801 is the fax button 702, it is determined that the selection of the guarantee registration method is FAX transmission. In a case where the CPU 101 determines that the selection of the guarantee registration method is FAX transmission, the processing proceeds to the step S820. In a case where the CPU 101 determines that the selection of the guarantee registration method is not FAX transmission, the processing proceeds to the step S821. It should be noted that in this case, the button pressed by the user in the step S801 is the file button 703.

In the step S820, the CPU 101 acquires a FAX number. The FAX number is, in the step S803, received from the registration management server 240 together with the format image of the registration sheet and each piece of entry field information. It should be noted that, in a case where the registration sheet with the FAX number thereon is attached to the multi-function peripheral 100, the CPU 101 causes the reading control part 113 and the reading part 114 to perform optical character recognition (OCR) processing on the registration sheet with the FAX number thereon. Thus, the CPU 101 may read and acquire the FAX number from the registration sheet attached to the multi-function peripheral 100.

In the step S821, the CPU 101 performs image transmission (outputting unit). In this processing, in a case where the selection of the guarantee registration method is FAX transmission, the CPU 101 transmits by FAX the data of the superimposed image, that is, the data of the registration sheet, with the FAX number acquired in the step S820 as a transmission destination. In contrast, in a case where the selection of the guarantee registration method is file transmission, the CPU 101 transmits the data of the superimposed image, that is, the data of the registration sheet as a file in a format such as PDF to the registration management server 240. Thus, the provider of the multi-function peripheral 100 can omit manual input in the business of guarantee registration. When the FAX transmission/file transmission is completed, the CPU 101 switches the display screen of the operation part 105 to the menu list screen 300.

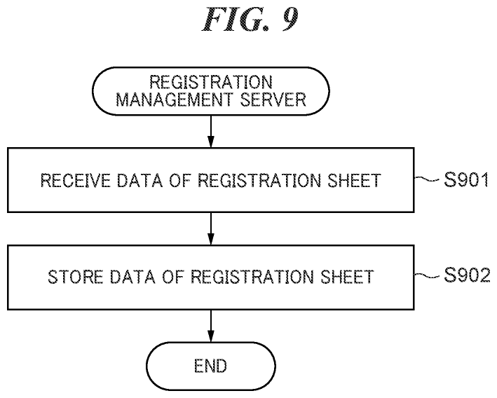

FIG. 9 is a flowchart of processing performed in the registration management server 240 according to the second embodiment. The registration management server 240 and the location information conversion server 260 perform processing of the flowcharts in FIG. 6 according to the first embodiment. Furthermore, the registration management server 240 performs each processing of the flowchart in FIG. 9. In a step S901, the registration management server 240 receives the data of the registration sheet transmitted via the file transmission from the multi-function peripheral 100. In a step S902, the registration management server 240 stores the received data of the registration sheet and performs registration processing.

As described above, according to the second embodiment, it is convenient because the user can select, on the multi-function peripheral 100, the guarantee registration method from among printing the registration sheet, transmitting by FAX the data of the registration sheet, and transmitting as a file the data of the registration sheet.

It should be noted that in the first embodiment, the CPU 101 may transmit the data of the superimposed image, that is, the data of the registration sheet by FAX transmission in the step S413. In the step S413, the CPU 101 may transmit the data of the superimposed image, that is, the data of the registration sheet via the file transmission. Further, in the second embodiment, the user may be allowed to select the guarantee registration method from printing and FAX transmission. Alternatively, the user may be allowed to select the guarantee registration method from printing and file transmission. Alternatively, the user may be allowed to select the guarantee registration method from FAX transmission and file transmission. Even in these cases, the time and effort can be saved in performing various types of registrations such as a guarantee registration.

Further, in the second embodiment, in a state in which the preview screen 710 is displayed on the operation part 105 in the step S814 (displaying unit), the user may be allowed to designate an entry field to be corrected among the entry fields in the superimposed image (designating unit). In such a case, when the user presses the entry field to be corrected in the superimposed image on the preview screen 710, the display screen of the operation part 105 transitions to a screen on which the entry field pressed by the user and the entry item therefor are displayed. Such a screen herein is referred to as the second selection screen 720. Then, the user presses the entry field to be corrected (as a correction target) in the superimposed image on the second selection screen 720 (second input screen), then the user can input (correct) characters to be entered in the entry field (correction receiving unit). Thus, the character string (correction information) of the input characters is superimposed in place of the character string which has been superimposed in the corresponding entry field of the superimposed image.

In this manner, the user can correct the contents (information/character string) in the entry field of the superimposed image, that is, the entry field of the registration sheet. Thus, the user can correct errors, and for example, in a case where the user is a resident of a condominium or an apartment, the user can add the numbers of the building and/or room. Furthermore, the user can recognize the entry field to be corrected (as a correction target) and the characters input in the entry field on the second selection screen 720, and thus easily performs a correcting operation. Thereafter, the display screen of the operation part 105 transitions to a preview screen 710. On the preview screen 710 at this time, the superimposed image obtained when the character string of the characters (information) input in the correcting operation is superimposed on the format image of the registration sheet is displayed as a preview. It should be noted that the CPU 101 can perform the above-described processing of correction in a configuration similar to that of the input processing in the steps S814 to S816. Further, the above-described processing of correction can also be applied to the first embodiment.

Furthermore, the first embodiment and the second embodiment can be applied not only to the above-described guarantee registration but also to a user registration.

In addition, in the first and second embodiments, the multi-function peripheral 100 receives the address information of the mobile terminal 120 from the location information conversion server 260 (step S409 and step S809). The multi-function peripheral 100 may, however, receive the address information of the mobile terminal 120 from the mobile terminal 120. Such reception is achieved, for example, with an application transmitted from the multi-function peripheral 100 to the mobile terminal 120 by near-field wireless communication.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-126486, filed Aug. 8, 2022, which is hereby incorporated by reference wherein in its entirety.

What is claimed is:

1. An information processing apparatus comprising:
at least one memory that stores a set of instructions; and
at least one processor that is configured to, based on the instructions, cause the information processing apparatus to:
acquire location information of a mobile terminal by using the mobile terminal in vicinity of the information processing apparatus;
receive, from a conversion server, address information obtained by the location information of the mobile terminal converted;
generate a superimposed image by superimposing the address information on an address entry field of the format image of a registration sheet; and
output the superimposed image.

2. The information processing apparatus according to claim 1, wherein the at least one processor further causes the information processing apparatus to:
determine a character size of a character string of the address information to be superimposed on the address entry field, based on a size of the address entry field of the format image of the registration sheet and a length of the character string of the address information to be superimposed on the address entry field.

3. The information processing apparatus according to claim 1, wherein an output of the superimposed image is printing of the superimposed image.

4. The information processing apparatus according to claim 1, wherein an output of the superimposed image is FAX transmission of the superimposed image.

5. The information processing apparatus according to claim 1, wherein an output of the superimposed image is file transmission of the superimposed image.

6. The information processing apparatus according to claim 1, wherein the at least one processor further causes the information processing apparatus to:
cause a user to select an output method for the superimposed image; and
output the superimposed image by the output method selected by the user.

7. The information processing apparatus according to claim 6, wherein the at least one processor further causes the information processing apparatus to:
display a selection screen for causing the user to select the output method for the superimposed image.

8. The information processing apparatus according to claim 6, wherein the at least one processor further causes the information processing apparatus to:
cause the user to select the output method for the superimposed image from at least two or more out of printing of the superimposed image, FAX transmission of the superimposed image, and file transmission of the superimposed image.

9. The information processing apparatus according to claim 5, wherein a transmission destination of the file transmission of the superimposed image is a registration management server.

10. The information processing apparatus according to claim 1, wherein the at least one processor further causes the information processing apparatus to:
acquire, as entry information, information corresponding to an entry field of the format image of the registration sheet, out of related information related to the information processing apparatus which is held in the information processing apparatus; and
superimpose the entry information on the entry field of the format image of the registration sheet to generate the superimposed image.

11. The information processing apparatus according to claim 10, wherein the at least one processor further causes the information processing apparatus to:
determine a character size of a character string of the entry information to be superimposed on the entry field, based on a size of the entry field of the format image of the registration sheet and a length of the character string of the entry information to be superimposed on the entry field.

12. The information processing apparatus according to claim 1, wherein the at least one processor further causes the information processing apparatus to:
receive input information input by a user as information corresponding to a blank of the superimposed image; and
superimpose the input information on the blank of the superimposed image to generate the superimposed image.

13. The information processing apparatus according to claim 12, wherein the at least one processor further causes the information processing apparatus to:
display a first input screen for the user to input the input information.

14. The information processing apparatus according to claim 1, wherein the at least one processor further causes the information processing apparatus to:
receive correction information input by a user as information corresponding to an entry field to be corrected of the superimposed image; and
superimpose the correction information, in place of the information which is already superimposed, on the entry field to be corrected in the superimposed image.

15. The information processing apparatus according to claim 14, wherein the at least one processor further causes the information processing apparatus to:
display a second input screen for the user to input the correction information.

16. The information processing apparatus according to claim 14, wherein
the at least one processor further causes the information processing apparatus to display the superimposed image as a preview, and
the entry field to be corrected of the superimposed image can be designated, by the user.

17. A method for controlling an information processing apparatus, comprising:
acquiring location information of a mobile terminal by using the mobile terminal in vicinity of the information processing apparatus;
receiving, from a conversion server, address information obtained by the location information of the mobile terminal converted;
generating a superimposed image by superimposing the address information on an address entry field of the format image of a registration sheet; and
outputting the superimposed image.

18. A non-transitory storage medium that stores a computer-executable program for executing a method for controlling an information processing apparatus,
the controlling method comprising:
acquiring location information of a mobile terminal by using the mobile terminal in vicinity of the information processing apparatus;
receiving, from a conversion server, address information obtained by the location information of the mobile terminal converted;
generating a superimposed image by superimposing the address information on an address entry field of the format image of a registration sheet; and
outputting the superimposed image.

19. An information processing system comprising an information processing apparatus, a registration management server, and a conversion server, which are connected to one another via a network, the information processing system comprising:
at least one memory that stores a set of instructions; and
at least one processor that is configured to, based on the instructions,
cause the information processing apparatus to:
transmit a registration sheet transmission request to the registration management server;
receive, from the registration management server, a format image of a registration sheet in accordance with the registration sheet transmission request;
acquire location information of a mobile terminal by using the mobile terminal in vicinity of the information processing apparatus;
transmit the location information of the mobile terminal to the conversion server;
receive, from the conversion server, address information obtained by the location information of the mobile terminal converted;
generate a superimposed image by superimposing the address information on the format image of the registration sheet; and
output the superimposed image,
cause the registration management server to:
receive the registration sheet transmission request from the information processing apparatus; and
transmit the format image of the registration sheet to the information processing apparatus, and
cause the conversion server to:
receive the location information of the mobile terminal from the information processing apparatus;
convert the location information of the mobile terminal to obtain the address information; and
transmit the address information to the information processing apparatus.
